(19) United States
(12) Patent Application Publication
(10) Pub. No.: US 2017/0083643 A1
(43) Pub. Date: Mar. 23, 2017

(54) REPRODUCING PROBLEMS IN A CLOUD-BASED REPLICA OF A NETWORK

(71) Applicant: Dell Products L.P., Round Rock, TX (US)

(72) Inventors: Jake Seigel, Halifax (CA); Aaron Champion, Dartmouth (CA)

(21) Appl. No.: 14/861,608

(22) Filed: Sep. 22, 2015

(51) Int. Cl. G06F 17/50; H04L 29/08

(52) U.S. Cl. CPC G06F 17/5009; H04L 67/10

(57) ABSTRACT

Systems and techniques to create a cloud-based replica system using configuration information gathered by agents deployed in the computing system are described. A replication server may remove customer-specific data from the configuration information. The replication server may identify domains of the cloud-based replica system which are not associated with recreating a problem and remove the domains from the cloud-based replica system. The cloud-based replica system may include multiple virtual hardware components. Individual virtual components of the multiple virtual hardware components may correspond to individual hardware components of the multiple hardware components. The replication server may create simulated users with replicated permissions and replicated credentials to simulate activities in the cloud-based replica system. The simulated activities may enable the problem to be recreated in the cloud-based replica system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A company may make software products that can be deployed in large customer networks, such as the networks of large businesses (e.g., enterprise networks). However, when a problem arises with a software product that has been deployed in a customer's network, duplicating the problem may be difficult because of the complexity of the enterprise network, the complexity of the software product, the complexity of the deployment of the software product, etc. Thus, technicians with the company that provided the software product may have difficulties duplicating or identifying the problem with the installation of the software product.

### SUMMARY

This Summary provides a simplified form of concepts that are further described below in the Detailed Description. This Summary is not intended to identify key or essential features and should therefore not be used for determining or limiting the scope of the claimed subject matter.

Systems and techniques to create a cloud-based replica system using configuration information gathered by agents deployed in the computing system are described. A replication server may remove customer-specific data from the configuration information. The replication server may identify domains of the cloud-based replica system which are not associated with recreating a problem and remove the domains from the cloud-based replica system. The cloud-based replica system may include multiple virtual hardware components. Individual virtual components of the multiple virtual hardware components may correspond to individual hardware components of the multiple hardware components. The replication server may create simulated users with replicated permissions and replicated credentials to simulate activities in the cloud-based replica system. The simulated activities may enable the problem to be recreated in the cloud-based replica system.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram illustrating a computing system that includes agents to gather configuration information according to some embodiments.

FIG. 2 is a block diagram illustrating a replication system according to some embodiments.

FIG. 3 is a flowchart of a process that includes installing multiple agents in a computing system according to some embodiments.

FIG. 4 is a flowchart of a process that includes creating a cloud-based replica of a computing system according to some embodiments.

FIG. 5 is a flowchart of a process that includes receiving configuration information associated with a computing system according to some embodiments.

FIG. 6 is a flowchart of a process that includes simulating activities in a cloud-based replica system according to some embodiments.

FIG. 7 illustrates an example configuration of a computing device that can be used to implement the systems and techniques described herein.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or video display. The information handling system may also include one or more buses operable to transmit communications between the various hardware components.

Systems and techniques are described herein to deploy multiple agents in a network (e.g., an enterprise network) to gather configuration information about the network to enable a problem being encountered in the network to be reproduced and resolved. For example, in some implementations, the multiple agents may be deployed on Active Directory® domain controllers or other similar domain controllers (e.g., servers that respond to security authentication requests such as logging in, checking permissions, etc. within a domain). The network may include multiple network elements, such as databases (e.g., database servers), user devices (e.g., workstations, laptops, tablets, phones, etc.), databases, communication links, and other types of devices that may be found in a network. The configuration information may include topology information, hardware configuration information, software configuration information, and other network-related information. For example, the network topology information may include information associated with how network elements (e.g., computers, servers, databases, and other network components) in the network are physically arranged, how the network elements are logically arranged, how the network elements are connected to each other, the types (e.g., wireless, wired, broadband, Ethernet, etc.) of connections (e.g., communication links) between network elements, and other information associated with how the network is logically and physically arranged. The hardware configuration information may include information associated with individual hardware components (e.g. network elements) in the network, such as a number of processors, a clock speed, a number of processor cores, an amount of main memory (e.g., random access memory (RAM)), an amount of disk space (e.g., hard drive or solid state drive), a bandwidth of communication links, and other hardware-related information. The software configuration information may include information related to software installed in individual network elements in the network, such as a type of operating system (e.g., Windows®, Unix®, Linux®, Android®, iOS®, or the like), an operating system version, a type of software application (structured query language (SQL), NoSQL, relational database, auditing software, event log generator, etc.), a version of the software application, and other software-related information.

After the agents gather configuration information associated with the computing system, the configuration information may be made generic (e.g., anonymous) by removing implementation specific information. For example, deployment-specific (e.g., enterprise-specific) data may be removed from the configuration information to create modified (e.g., cleaned) configuration information, e.g., genericized information. For example, the deployment-specific data that is removed may include user names, user name related data, metadata that may be used to identify user names, email addresses, job codes, domain names, server names, port numbers, internet protocol (IP) addresses, active directory group names, file names, document names, Sharepoint® site names, etc.

The modified (e.g., anonymized) configuration information may be used by a replication server to create a cloud-based replica system of the customer's network. The cloud-based replica system may include cloud-based replicas of the hardware components in the customer's network and running cloud-based replicas of the software components in the customer's network. The replicated hardware components and software components may include exact replicas or the closest available equivalents to the components in the customer's network. For example, a hardware component of the customer's network may use a particular type of processor, having a particular number of cores, running at a particular clock speed. The cloud-based replica of a hardware component may be selected based on being the closest available equivalent available to the replication server and may have a different type of processor, a different number of cores, a different clock speed, another difference, or any combination thereof. For example, a cloud-based replica server may use an older (or newer) Intel® i5 processor compared to a physical server in the customer's network. The cloud-based replica of a software component may be the closest available equivalent and may have an older (or newer) version etc. as compared to the software component in the customer's network. For example, a cloud-based replica server may use an operating system that is one version older (or newer) compared to a physical server in the customer's network, e.g., Windows® 8.0 instead of Windows® 8.1, or Windows N (e.g., where N is 7 or greater) with Service Pack I instead of Windows N with Service Pack II. The cloud-based replica system may be configured based on the configuration information to replicate the configuration of the customer's network. For example, a topology of the cloud-based replica system may resemble the topology of the customer's network, e.g., the replicated hardware components may be arranged according to the arrangement of the hardware components in the customer's network.

In some cases, portions of the customer's network that are determined to be not associated with a problem (e.g., not needed to reproduce the problem) that the customer is encountering may be excluded from the cloud-based replica system. For example, if the customer is encountering a problem related to databases, portions of the cloud-based replica system that do not interact with the databases may be removed, deactivated, or otherwise excluded from the cloud-based replica system. In this way, the cloud-based replica system may be modified to remove or deactivate portions of the cloud-based replica system.

Based on the modified configuration information, simulated users may be created with permissions, credentials, etc. similar to the users of the customer's network. The simulated users may be used to simulate activities in the cloud-based replica system similar to the activities that users perform in the customer's network. For example, the configuration information gathered by the agents may include information associated with the types of activities that users perform and may be used to simulate user activities in the cloud-based replica system. In addition to simulating user activities, the configuration information may be used to simulate other activities in the replicated system, such as activities performed by software processes (e.g., automatic data backup), activities that automatically take place as a result of user activities, etc. The simulated user activities may be used to determine potential problems and identify suggested solutions to the potential problems. For example, the simulated activities may be used to identify problems due to incorrect software (or software version) being deployed, incorrect software configurations, incorrect hardware configurations, inefficient network topology, hardware that doesn't satisfy the requirements of software deployed on the hardware, incorrect or inefficient (e.g., 10Base-T links instead of 100Base-T links) communications link between network elements, etc. A classifier (e.g., a machine learning algorithm) may be trained to identify potential solutions to address the potential problems. In some cases, even if the problems that the customer is encountering are not reproducible using the cloud-based replica system, the configuration problems in the customer's network may manifest as other types of problems in the cloud-based replica system and lead to solutions being identified that address the customer's problems. In this way, problems in the customer's network may be identified by creating a cloud-based replica system and simulating activities (e.g., user activities).

Thus, agents may be deployed in a customer's network (e.g., enterprise network) to gather configuration information. The configuration information may be scrubbed (e.g., cleaned) by removing customer specific information. The cleaned configuration information may be used to create a cloud-based replica system corresponding to the customer's network and to simulate activities (e.g., user activities, activities of software processes, etc.). The simulated activities may be used to identify potential problems (e.g., configuration problems) with the customer's network and suggest solutions to address the potential problems. In this way, a software vendor, a hardware vendor, or a solutions vendor may quickly and easily reproduce problems that a customer is encountering and suggest solutions to address the problems, resulting in fewer problems in the customer's network and greater customer satisfaction.

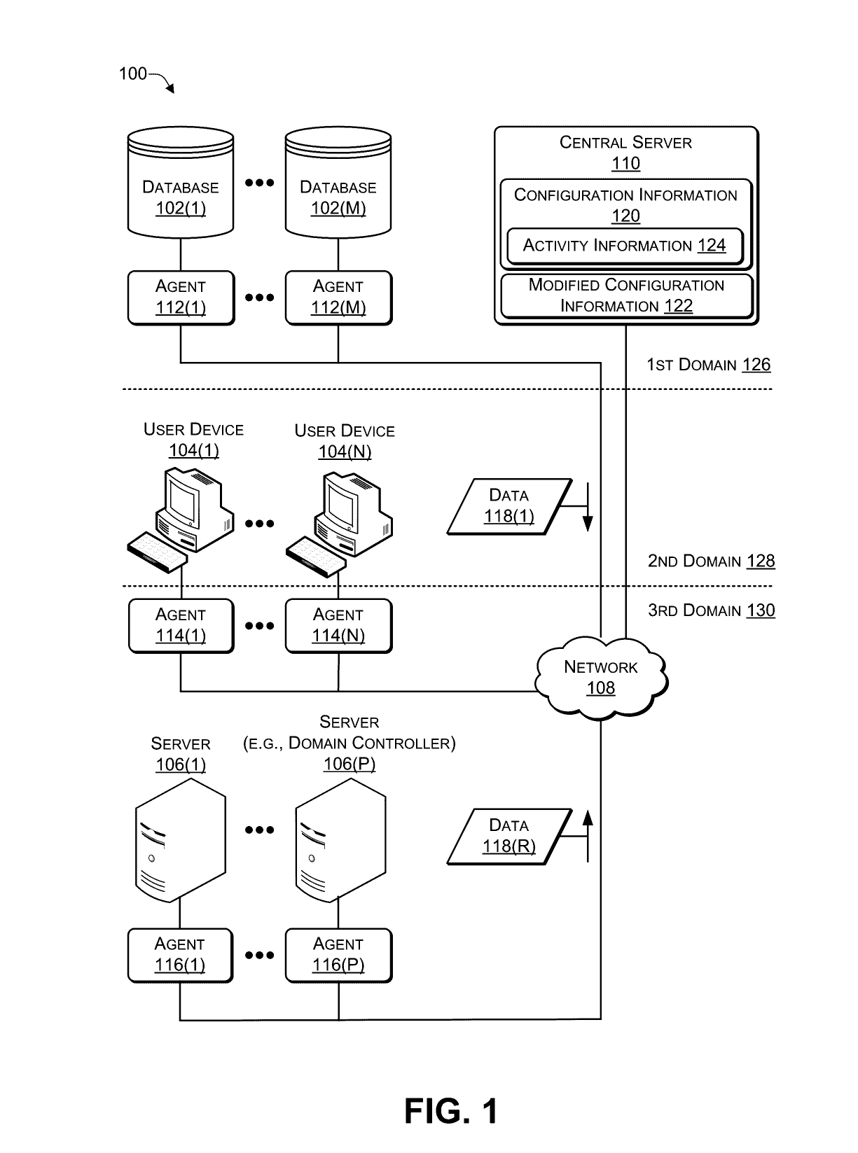

FIG. 1 is a block diagram illustrating a computing system 100 that includes agents to gather configuration information according to some embodiments. The computing system 100 may include multiple types of network elements, including a representative one or more databases, such as a database 102(1) to a database 102(M), a representative one or more user devices, such as a user device 104(1) to a user device 104(N), and a representative one or more servers, such as a server 106(1) to a server 106(P), where M>1, N>1, and P>1, and where M, N, and P are not necessarily the same. Of course, the computing system 100 may include other network elements besides or in addition to the databases 102, the user devices 104, and the servers 106. The user devices 104 may include workstations, laptops, tablets, wireless phones, other types of computing devices used to access other network elements of the computing system 100, or any combination thereof. The network elements 102, 104, and 106 may be connected via a network 108 to a central server 110.

At least some of the network elements of the computing system 100 may have an associated agent that monitors a particular component and gathers configuration information associated with the computing system 100. For example, individual ones of agents 112(1) to 112(M) may be associated with a particular one of the databases 102(1) to 102(M) (e.g., the agent 112(1) may be associated with the database 102(1) and the agent 112(M) may be associated with the database 102(M)). Individual ones of agents 114(1) to 114(N) may be associated with a particular one of the user devices 104(1) to 104(N) (e.g., the agent 114(1) may be associated with the user device 104(1) and the agent 114(N) may be associated with the user device 104(N)). Individual ones of the agents 116(1) to 116(P) may be associated with a particular one of the servers 106(1) to 106(P) (e.g., the agent 116(1) may be associated with the server 106(1) and the agent 116(P) may be associated with the server 106(P)).

The agents 112, 114, 116 may be placed in locations in the computing system 100 that enable the agents 112, 114, 116 to gather configuration information from data 118(1) to 118(R). To illustrate, the agents 112, 114, 116 may be placed locations that enable the agents 112, 114, 116 to extract information from traffic (e.g., the data 118) to and from Active Directory® domain controllers or other network elements. A domain controller is a server that responds to security authentication requests (e.g., login requests, authenticate permissions, etc.) within a domain, where a domain is a set of computer resources that may be accessed using a single username and password combination. The computing system 100 may include multiple domains, with each domain including a portion of the computer resources in the computing system 100. The agents 112, 114, 116 may identify configuration information 120 based on the data 118 traffic in the computing system 100 (e.g., traffic to and from domain controllers or other servers), enabling the central server 110 to create the configuration information 120. The configuration information 120 may describe details associated with the computing system 100, such as a network topology of the computing system 100, information about the hardware components, the software components, and the communication links of the computing system 100, information describing how the hardware components, the software components, and the communication links are configured, and the like. The configuration information 120 may include information associated with one or more domains, such as a first domain 126 that includes the databases 102, a second domain 128 that includes the user devices 104, and a third domain 130 that includes the servers 106. Of course, the domains 126, 128, 130 in the computing system 100 may be configured in other ways. For example, in another configuration, the first domain 126 may include the database 102(1), the user device 104(1), and the server 106(1).

The agents 112, 114, 116 may monitor data 118 traffic in the computing system 100 (e.g., an enterprise network) to gather the configuration information 120. The configuration information 120 may be used to replicate the computing system 100 to enable a problem being encountered in the computing system 100 to be replicated (e.g., reproduced) and resolved. The configuration information 120 may include topology information, hardware configuration information, software configuration information, and other network-related information. For example, the network topology information may include information associated with how network elements (e.g., computers, servers, databases, and other network components) in the network are physically arranged, how the network elements are logically arranged, how the network elements are connected to each other, the types (e.g., wireless, wired, broadband, Ethernet, etc.) of connections (e.g., communication links) between network elements, and other information associated with how the network is logically and physically arranged. The configuration information 120 may include information associated with individual hardware components (e.g. network elements) in the network, such as a number of processors, a clock speed, a number of processor cores, an amount of main memory (e.g., random access memory (RAM)), an amount of disk space (e.g., hard drive or solid state drive), a bandwidth of communication links, and other hardware-related information. The configuration information 120 may include information related to software installed in individual network elements in the network, such as a type of operating system (e.g., Windows®, Unix®, Linux®, Android®, iOS®, or the like), an operating system version, a type of software application (structured query language (SQL), NoSQL, relational database, auditing software, event log generator, etc.), a version of the software application, and other software-related information.

Based on the data 118 examined by the agents 112, 114, 116, the central server 110 may determine the configuration information 120 associated with the computing system 100. The central server 110 may remove deployment-specific (e.g., enterprise-specific and customer-specific) data from the configuration information 120 to create modified (e.g., generic or anonymous) configuration information 122. For example, the deployment-specific data that is removed from the configuration information 120 may include user names, user name related data, metadata that may be used to identify user names, email addresses, job codes, domain names, server names, port numbers, internet protocol (IP) addresses, active directory group names, file names, document names, Sharepoint® site names, and other customer-specific information. The modified (e.g., cleaned) configuration information may be used by a replication server to create a cloud-based replica system of the customer's network, as described in more detail below. The configuration information 120 may include activity information 124 associated with activities (e.g. user activities performed by users interacting with the computing system 100, component activities performed by hardware components or software components in the computing system 100, or both). For example, the activity information 124 may include event logs generated by auditing software, such as Dell Change Auditor®.

Thus, the agents 112, 114, 116 may be deployed in a customer's network (e.g., enterprise network) to gather the configuration information 120. The configuration information 120 may be scrubbed (e.g., cleaned) by removing deployment (e.g., customer-centric) specific information to create the modified configuration information 122. For example, the modified configuration 122 may include anonymized information (e.g., genericized information) that does not include deployment specific information that is unrelated to the configuration of the computing system 100. The modified configuration information 122 may be used to create a cloud-based replica system corresponding to the customer's network and to simulate activities (e.g., user activities, activities of software processes, etc.). The simulated activities may be used to identify potential problems (e.g., configuration problems) with the customer's network and suggest solutions to address the potential problems. In this way, a software vendor, a hardware vendor, or a solutions vendor may quickly and easily reproduce problems that a customer is encountering and suggest solutions to address the problems, resulting in fewer problems in the customer's network and greater customer satisfaction.

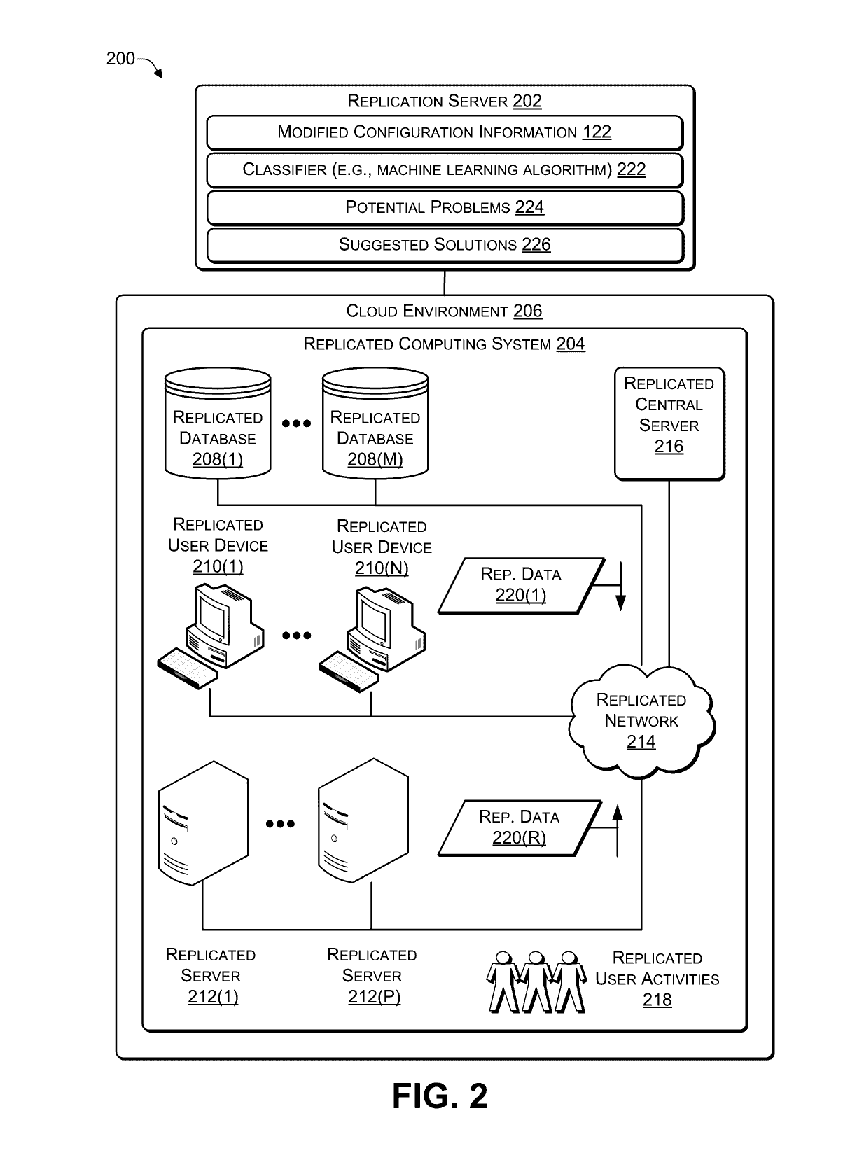

FIG. 2 is a block diagram illustrating a replication system 200 according to some embodiments. A replication server 202 may use the modified configuration information 122 to create a replicated computing system 204 in a cloud environment 206. The replication server 202 may be a hardware device with a memory to store instructions that are executable by one or more hardware processors to perform the various functions described herein. The replicated computing system 204 may correspond to at least a portion of the computing system 100 and may be used to replicate problems that a business (e.g., enterprise) using the computing system 100 is encountering. The replicated computing system 204 may include virtual hardware components corresponding to the hardware components in the customer's network (e.g., the computing system 100) and software components corresponding to the software components in the customer's network. For example, a hardware server may be replicated using a virtual machine with similar or identical characteristics. To illustrate, a hardware server with an Intel i5 processor, 8 gigabytes (GB) of memory, and 2 terabytes (TB) of disk space may be replicated using a virtual machine having the processing power equivalent to an Intel i5, 8 GB of virtual memory, and 2 TB of virtual disk space. If the hardware component has Windows 8 and SQL server version X.Y installed, then the replicated hardware component may have Windows 8 and SQL server version X.Y installed.

The replication server 202 may receive the configuration information 120 or the modified configuration information 122 from the central server 110 of FIG. 1. If the replication server 202 receives the configuration information 120, the replication server may remove customer-specific information from the configuration information 120 to create the modified configuration information 122. The replication server 202 may use the modified (e.g., cleaned) configuration information 122 to create a cloud-based replica system, e.g., the replicated computing system 204, corresponding to the customer's network (e.g., the computing system 100). The replicated computing system 204 may include cloud-based replicas of the hardware components (e.g., network elements) in the customer's network and the hardware components may execute cloud-based software components corresponding to the customer's network.

The replicated hardware components and software components in the replicated computing system 204 may include the closest equivalents to the hardware components and the software components in the customer's network that are available in the cloud environment 206. For example, a network element of the computing system 100 may use a particular type of processor, having a particular number of cores, running at a particular clock speed. The cloud-based replica of the network element may be the closest available equivalent in the cloud environment 206 and may have a different type of processor, a different number of cores, a different clock speed, another difference, or any combination thereof. For example, a cloud-based replica server may use an older (or newer) Intel® i5 processor compared to a physical server in the computing system 100. The cloud-based replica of a software component may be the closest available equivalent and may have an older (or newer) version etc. as compared to the software component in the computing system 100. For example, a cloud-based replica server may use an operating system that is one version older (or newer) compared to a physical server in the computing system 100, e.g., Windows® 8.0 instead of Windows® 8.1, or Windows N (e.g., where N is 7 or greater) with Service Pack I instead of Windows N with Service Pack II. The replicated computing system 204 may be configured based on the modified configuration information 122 to closely resemble the configuration of the customer's network (e.g., the computing system 100). For example, a topology of the replicated computing system 204 may closely resemble the topology of the computing system 100, e.g., the components in the replicated computing system 204 may be arranged according to the arrangement of the hardware components in the computing system 100.

As illustrated in FIG. 2, the replicated computing system 204 may include (a) replicated databases 208(1) to 208(M) corresponding to the databases 102(1) to 102(M) of the computing system 100, (b) replicated user devices 210(1) to 210(N) corresponding to the user devices 104(1) to 104(N) of the computing system 100, (c) replicated servers 212(1) to 212(P) corresponding to the servers 106(1) to 106(P) of the computing system 100, (d) a replicated network 214 corresponding to the network 108, and (e) a replicated central server 216 corresponding to the central server 110. Based on the modified configuration information 122, the replication server 202 may replicate the types of activities that occur in the computing system 100, including generating replicated user activities 218 to replicate the type of activities that users perform in the computing system 100 and replicating activities that cause replicated data 220(1) to 220(R) (e.g., corresponding to the data 118(1) to 118(R)) to be generated.

In some cases, portions of the customer's network that are determined to be not directly related with a problem that the customer is encountering may be excluded from the replicated computing system 204. For example, if the customer is encountering a problem related to databases 102, portions of the replicated computing system 204 that do not interact with the replicated databases 208 may be removed, deactivated, or otherwise excluded from the replicated computing system 204. As another example, both the computing system 100 and the replicated computing system 204 may include four domains and the customer may be encountering a problem in a first domain that has little or no interaction with the remaining domains. In this example, the remaining domains may be removed or deactivated from the replication computing system 204, leaving the first domain active to reproduce the problem. In this way, the replicated computing system 204 may be modified to remove or deactivate particular portions (e.g., domains) of the replicated computing system 204. By doing so, the amount of cloud computing resources in the cloud environment 206 that are used to reproduce the customer's problem may be reduced.

Based on the modified configuration information 122, simulated users may be created with permissions, credentials, etc. similar to the users of the customer's network. The simulated users may be used to simulate activities (e.g., the replicated user activities 218) in the replicated computing system 204 that are similar to the activities that users may perform in the customer's network. For example, the modified configuration information 122 may include information associated with the types of activities that users perform and may be used to simulate user activities (e.g., the replicated user activities 218). In addition to simulating user activities, the modified configuration information 122 may be used to simulate other activities in the replicated system, such as activities performed by software processes (e.g., automatic data backup), activities that automatically take place as a result of the user activities, etc. The replicated activities (e.g., the replicated user activities 218 and the replicated data 220) may be used to determine potential problems 224 and identify suggested solutions 226 to the potential problems 224. For example, the simulated activities may be used to identify problems caused by installing incorrect software (or an incorrect software version), incorrectly configured software, incorrectly configured hardware, inefficient network topology, hardware that doesn't satisfy the requirements of software installed on the hardware, incorrect or inefficient (e.g., 10Base-T links instead of 100Base-T links) communication links between network elements, etc. A classifier (e.g., a machine learning algorithm) may be trained to identify the potential problems 224 and the potential solutions 226 to address the potential problems 224. In some cases, even if the problems that the customer is encountering are not reproducible or only partially reproducible using replicated computing system 204, the configuration problems in the customer's network may manifest as other types of problems in the replicated computing system 204 and lead to solutions that address at least some of the customer's problems. In this way, problems in the customer's network (e.g., the computing system 100) may be identified by creating the replicated computing system 204 and simulating activities.

The replication server 202 may include software to modify the configuration information 120 to create the modified configuration information 122 and to create the replicated computing system 204 in the cloud environment 206 based on the modified configuration information 122. The replication server 202 may identify portions (e.g., domains, hardware components, and the like) of the replicated computing system 204 that may not directly affect a problem and remove (or deactivate) the identified portions from the replicated computing system 204. The replication server 202 may display a user interface to enable a user to modify the replicated computing system 204 by enabling the user to change hardware configurations, software configurations, add or remove portions of the replicated computing system 204, and the like. In some cases, the replication server 202 may display a user interface and the user may remove (or deactivate) portions of the replicated computing system 204 that do not directly affect a problem.

After a potential problem has been identified using the replicated computing system 204, the replication server 202 may provide a user interface to enable the user to modify the replicated computing system 204 to determine whether a suggested solution addresses the problem. To illustrate, the replication server 202 may create the replicated computing system 204 and simulate activities based on the activity information 124. After a potential problem is identified, the user may use the replication server 202 to modify the replicated computing system 204 to create a first modified configuration to address the problem. For example, the user may change a hardware configuration of a hardware component (e.g., more processing power, more storage, and the like), change the software configuration of a software component, change system user credentials, change permissions of one or more system users, change permissions of one or more processes, add or remove hardware components, add or remove software components, change domain configurations, modify ports, etc.

The user may instruct the replication server 202 to simulate the activities in the first modified configuration. If the problem is addressed, the user may make the same or similar modifications to the customer's network (e.g., the computing system 100). If the problem is not addressed or another problem arises, the user may make additional modifications to create a second modified configuration, instruct the replication server 202 to simulate the activities in the second modified configuration, and so on until the user is satisfied that the problems have been addressed.

The event activities that the replication server 202 simulates in the replicated computing system 204 may include activities based on event logs generated by auditing software, such as Dell Change Auditor®. For example, the simulated activities may be generated based on the activity information 124 of FIG. 1 and may include configuration changes associated with Active Directory®, SQL Server®, Lync®, SharePoint®, file systems, EMU), NetApp®, etc. The activity information 124 (e.g., event logs) may be scrubbed of customer-specific information and used to recreate the event logs in the replicated computing system 204, with mock data injected into the event logs. For example, an event log in the computing system 100 that is generated when John Smith uses username “john.smith” to logon to domain “Acme-explosives-1,” may be scrubbed and used to simulate an event in the replicated computing system 204 in which mock user ABC uses username “abc” to logon to domain “xyz-domain-1.” As another example, an activity may be simulated in the replicated computing system 204 to generate an event log indicating that “user <MockUser1> deleted file <MockFile1> on server <MockServerName1>.” As yet another example, an event may be simulated in the replicated computing system 204 to generate an event log indicating that “a user session for <mock username> took place on mock <computer name>.” As a further example, an event may be simulated in the replicated computing system 204 to generate an event log indicating that “<mock username> added a row to table <mock table name> in SQL Server <mock server name>.” The activities simulated in the replicated computing system 204 may include configuration change events, e.g., changes to configurations of software components, changes to configurations of hardware components, and the like. For example, an event log may be generated when a software agent template (e.g., identifying how each software agent audits a respective set of components in the network) is changed.

Thus, when a customer has a problem in a computing system, a computer systems integrator may deploy agents to gather the configuration information 120. The configuration information 120 may be “cleaned” to remove customer specific information to create the modified configuration information 122. The replicated computing system 204 that mimics the customer's network may be created in the cloud environment 206 using the modified configuration information 122. The replicated computing system 204 may include (a) mock user accounts to generate the replicated user activities, (b) permissions that are setup to correspond to the network topology of the customer's network, (c) sanitized event data (e.g., the activity information 124), (d) virtual domains and virtual servers corresponding to domains and servers in the customer's network, (e) software and virtual hardware components corresponding to the customer's network, and (f) other configuration-relate components that correspond to the customer's network. Creating the replicated computing system 204 may be automated using scripts for the cloud environment 206 (e.g., VMware™ systems or the like) or Dell® KACE® deployment manager appliances. In cases where an installation action is to be confirmed, a lightweight agent may be installed to manage the deployment and configuration of software components. The lightweight agent may confirm that software components have been successfully installed and configured. Most installers either fail or succeed; the lightweight agent determines whether a software component was properly installed and configured. In addition, deployment visualization software executing on the replication server 202 may use the modified configuration information 122 to create a visual display of the replicated computing system 204 that identifies major hardware components, major software components, and the network topology. Such a display may enable a user to remove (or deactivate) portions of the replicated computing system that are unrelated to a particular problem. For example, if the customer is experiencing a problem related to a Microsoft® Exchange® product, portions of the replicated computing system 204 that include workstations and SharePoint® may not affect the problem. In this example, the workstations and SharePoint® may be removed (or deactivated) from the replicated computing system 204 while enabling the problem to reproduced in the replicated computing system 204. Therefore, the replicated computing system 204 may include the software components, the hardware components, portions of the network topology, the domains etc. that enable to the problem to be reproduced while components of the replicated computing system 204 that are unrelated to reproducing the problem may be removed or deactivated.

Thus, agents may be deployed in a customer's network (e.g., enterprise network) to gather configuration information. The configuration information may be scrubbed (e.g., cleaned) by removing customer specific information. The modified configuration information 122 may be used to create the replicated computing system 204 system corresponding to the customer's network and to simulate activities (e.g., the replicated user activities 218 and activities that cause the replicated data 220). The simulated activities may be used to identify the potential problems 224 (e.g., configuration problems) and identify the suggested solutions 226. In this way, a software vendor, a hardware vendor, or a solutions vendor may quickly and easily reproduce problems that a customer is encountering and suggest solutions to address the problems, resulting in fewer problems in the customer's network and greater customer satisfaction. The problems may be safely reproduced in a cloud environment without affecting the operation of the customer's network. Thus, potential problems in a customer's network may be identified in a way that does not impact the customer's network.

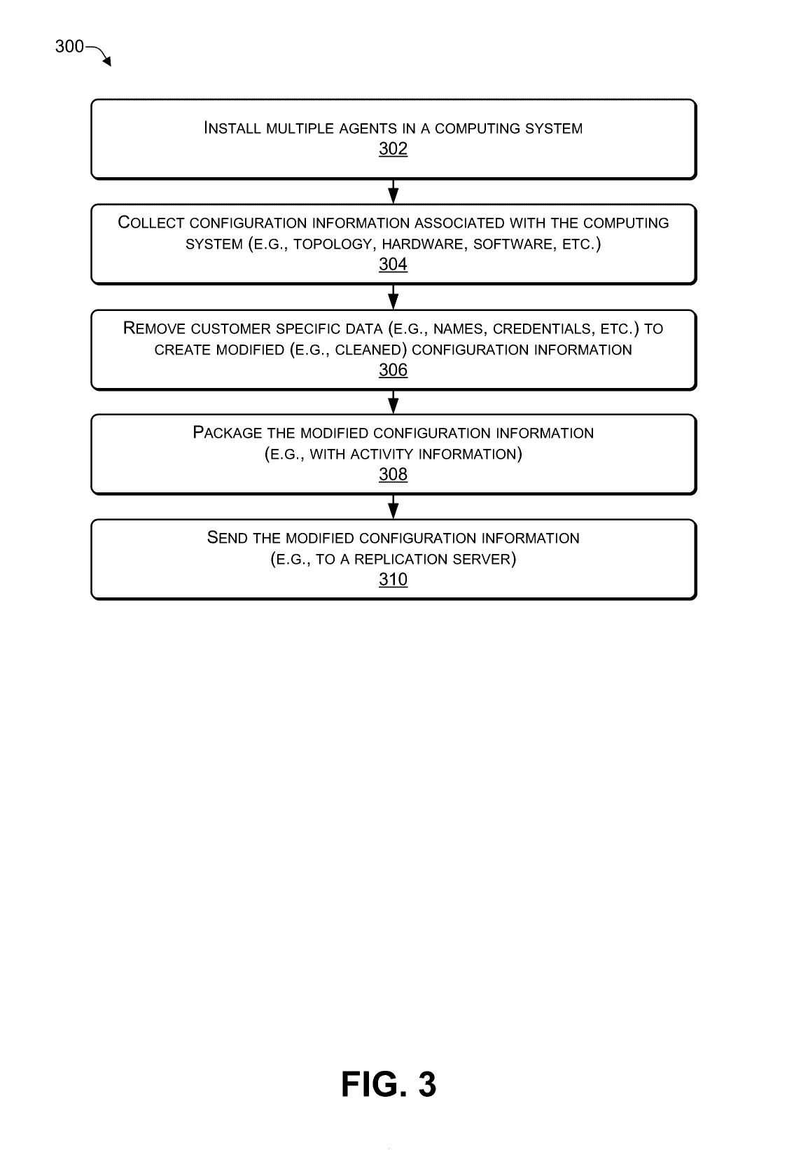

In the flow diagrams of FIGS. 3, 4, 5, and 6, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 300, 400, 500, and 600 are described with reference to FIGS. 1, 2, and 3 as described above, although other models, frameworks, systems and environments may implement these processes.

FIG. 3 is a flowchart of a process 300 that includes installing multiple agents in a computing system according to some embodiments. The process 300 may be performed by the central server 110 of FIG. 1.

At 302, multiple agents may be installed in a computing system. At 304, configuration information associated with the computing system may be collected. At 306, customer specific data may be removed from the configuration information to create modified configuration information. At 308, the modified configuration information may be packaged (e.g., along with data logs, along with information associated with user activities, etc.). At 310, the packaged configuration information may be sent (e.g., to a replication server).

For example, in FIG. 1, the central server may install the agents 112, 114, 116 in the computing system 100 (e.g., an enterprise network) to gather the configuration information 120. The configuration information 120 may be used to replicate the computing system 100 to enable a problem being encountered in the computing system 100 to be replicated (e.g., reproduced) and resolved. The configuration information 120 may include topology information, hardware configuration information, software configuration information, and other network-related information. For example, the network topology information may include information associated with how network elements (e.g., computers, servers, databases, and other network components) in the network are physically arranged, how the network elements are logically arranged, how the network elements are connected to each other, the types (e.g., wireless, wired, broadband, Ethernet, etc.) of connections (e.g., communication links) between network elements, and other information associated with how the network is logically and physically arranged. The configuration information 120 may include information associated with individual hardware components (e.g. network elements) in the network, such as a number of processors, a clock speed, a number of processor cores, an amount of main memory (e.g., random access memory (RAM)), an amount of disk space (e.g., hard drive or solid state drive), a bandwidth of communication links, and other hardware-related information. The configuration information 120 may include information related to software installed in individual network elements in the network, such as a type of operating system (e.g., Windows®, Unix®, Linux®, Android®, iOS®, or the like), an operating system version, a type of software application (structured query language (SQL), NoSQL, relational database, auditing software, event log generator, etc.), a version of the software application, and other software-related information.

The central server 110 may remove customer-specific data from the configuration information 120 to create the modified (e.g., cleaned) configuration information 122. For example, the customer-specific data that is removed from the configuration information 120 may include user names, user name related data, metadata that may be used to identify user names, email addresses, job codes, domain names, server names, port numbers, internet protocol (IP) addresses, active directory group names, file names, document names, Sharepoint® site names, and other customer-specific information. The modified (e.g., cleaned) configuration information may be sent to a replication server to create a cloud-based replica system of the customer's network.

Thus, agents may be deployed in a customer's network (e.g., enterprise network) to gather configuration information. The configuration information may be scrubbed (e.g., cleaned) by removing customer specific information to create modified configuration information. The modified configuration information may sent to a replication server to create a cloud-based replica system corresponding to the customer's network. The replication server may simulate activities (e.g., user activities, activities of software processes, etc.) that occur in the cloud-based replica system based on the modified configuration data. Based on the simulated activities, the replication server may identify potential problems (e.g., configuration problems) with the customer's network and suggest solutions to address the potential problems. For example, a classifier (e.g., machine learning algorithm) may be used to identify the potential problems. In this way, a software vendor, a hardware vendor, or a solutions vendor may quickly and easily reproduce problems that a customer is encountering without significantly impacting the customer's network.

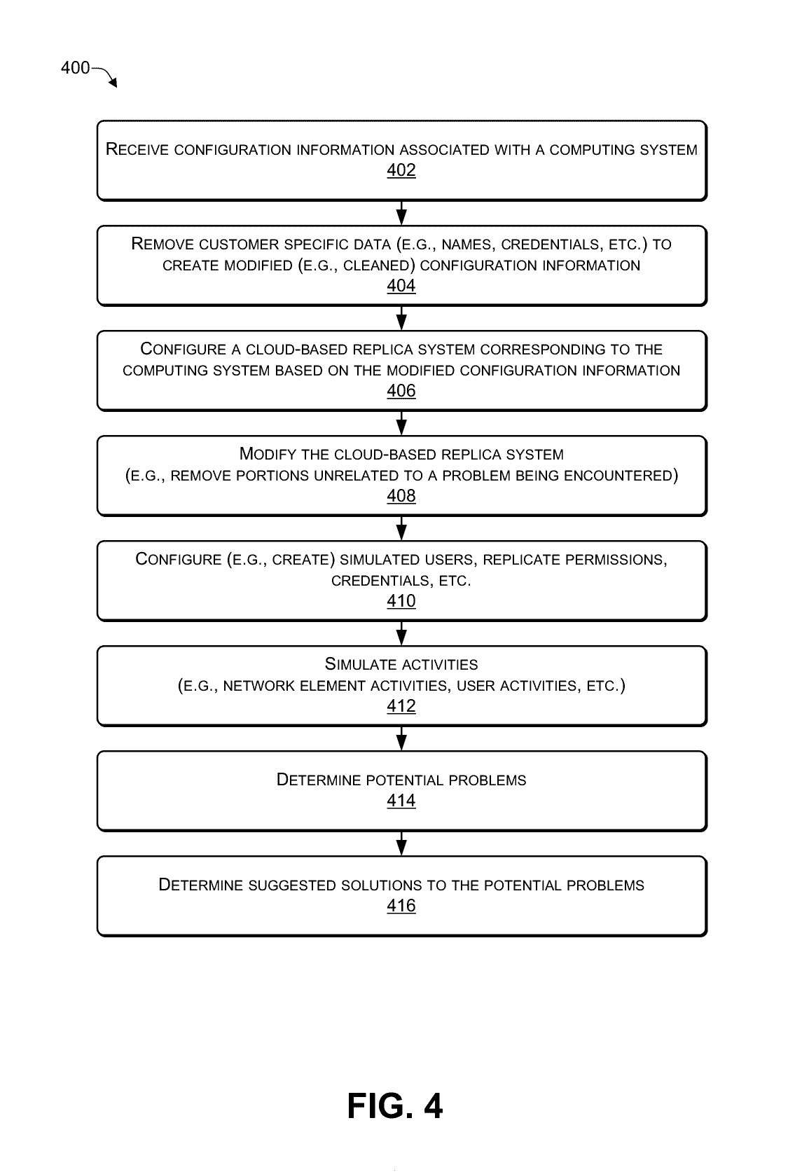

FIG. 4 is a flowchart of a process 400 that includes creating a cloud-based replica of a computing system according to some embodiments. The process 400 may be performed by the replication server 202 of FIG. 2.

At 402, configuration information associated with a computing system may be received. At 404, customer specific data may be removed from the configuration information to create modified configuration information. At 406, a cloud-based replica system corresponding to the computing system may be configured (e.g., instantiated) based on the modified configuration information. For example, in FIG. 2, the replication server 202 may receive the configuration information 120 (or the modified configuration information 122) from the central server 110 of FIG. 1. If the replication server 202 receives the configuration information 120, the replication server 202 may remove customer-specific information from the configuration information 120 to create the modified configuration information 122. The replication server 202 may use the modified (e.g., cleaned) configuration information 122 to create a cloud-based replica system, e.g., the replicated computing system 204, corresponding to the customer's network (e.g., the computing system 100). The replicated computing system 204 may include cloud-based replicas of the hardware components (e.g., network elements) in the customer's network and the hardware components may execute cloud-based software components corresponding to the customer's network. The replicated hardware components and software components in the replicated computing system 204 may include the closest equivalents to the hardware components and the software components in the customer's network that are available in the cloud environment 206.

At 408, the cloud-based replica system may be modified (e.g., to remove portions of the network that are unrelated to the problem that the customer is encountering that the replicated system is trying to reproduce). For example, in FIG. 2, portions of the customer's network that are determined to be not directly related with a problem that the customer is encountering may be excluded from the replicated computing system 204. For example, if the customer is encountering a problem related to databases 102, portions of the replicated computing system 204 that do not interact with the replicated databases 208 may be removed, deactivated, or otherwise excluded from the replicated computing system 204. As another example, both the computing system 100 and the replicated computing system 204 may include four domains and the customer may be encountering a problem in a first domain that has little or no interaction with the remaining domains. In this example, the remaining domains may be removed or deactivated from the replication computing system 204, leaving the first domain active to reproduce the problem. In this way, the replicated computing system 204 may be modified to remove or deactivate particular portions (e.g., domains) of the replicated computing system 204. By doing so, the amount of cloud computing resources in the cloud environment 206 that are used to reproduce the customer's problem may be reduced.

At 410, simulated users may be created with permissions and credentials that replicate users of the computing system. At 412, activities (e.g., user activities, software activities, hardware activities, and other system activities) may be simulated. For example, in FIG. 2, based on the modified configuration information 122, the replication server 202 may replicate the types of activities that occur in the computing system 100, including generating replicated user activities 218 to replicate the type of activities that users perform in the computing system 100 and replicating activities that cause replicated data 220(1) to 220(R) (e.g., corresponding to the data 118(1) to 118(R)) to be generated. Based on the modified configuration information 122, simulated users may be created with permissions, credentials, etc. similar to the users of the customer's network. The simulated users may be used to simulate activities (e.g., the replicated user activities 218) in the replicated computing system 204 that are similar to the activities that users may perform in the customer's network. For example, the modified configuration information 122 may include information associated with the types of activities that users perform and may be used to simulate user activities (e.g., the replicated user activities 218). In addition to simulating user activities, the modified configuration information 122 may be used to simulate other activities in the replicated system, such as activities performed by software processes (e.g., automatic data backup), activities that automatically take place as a result of the user activities, etc.

At 414, potential problems may be identified. At 414, suggested solutions to the potential problems may be identified. For example, in FIG. 2, the replicated activities (e.g., the replicated user activities 218 and the replicated data 220) may be used to determine potential problems 224 and identify suggested solutions 226 to the potential problems 224. For example, the simulated activities may be used to identify problems caused by installing incorrect software (or an incorrect software version), incorrectly configured software, incorrectly configured hardware, inefficient network topology, hardware that doesn't satisfy the requirements of software installed on the hardware, incorrect or inefficient (e.g., 10Base-T links instead of 100Base-T links) communication links between network elements, etc. A classifier (e.g., a machine learning algorithm) may be trained to identify the potential problems 224 and the potential solutions 226 to address the potential problems 224. In some cases, even if the problems that the customer is encountering are not reproducible or only partially reproducible using replicated computing system 204, the configuration problems in the customer's network may manifest as other types of problems in the replicated computing system 204 and lead to solutions that address at least some of the customer's problems. In this way, problems in the customer's network (e.g., the computing system 100) may be identified by creating the replicated computing system 204 and simulating activities.

Thus, agents may be deployed in a customer's network (e.g., enterprise network) to gather configuration information. The configuration information may be scrubbed (e.g., cleaned) by removing customer specific information. The modified configuration information may be used to create a replicated computing system corresponding to the customer's network and to simulate activities. The simulated activities may be used to identify potential problems (e.g., configuration problems) and identify suggested solutions. In this way, a software vendor, a hardware vendor, or a solutions vendor may quickly and easily reproduce problems that a customer is encountering and suggest solutions to address the problems, resulting in fewer problems in the customer's network and greater customer satisfaction. The problems may be safely reproduced in a cloud environment without affecting the operation of the customer's network. Thus, potential problems in a customer's network may be identified with little impact on the customer's network.

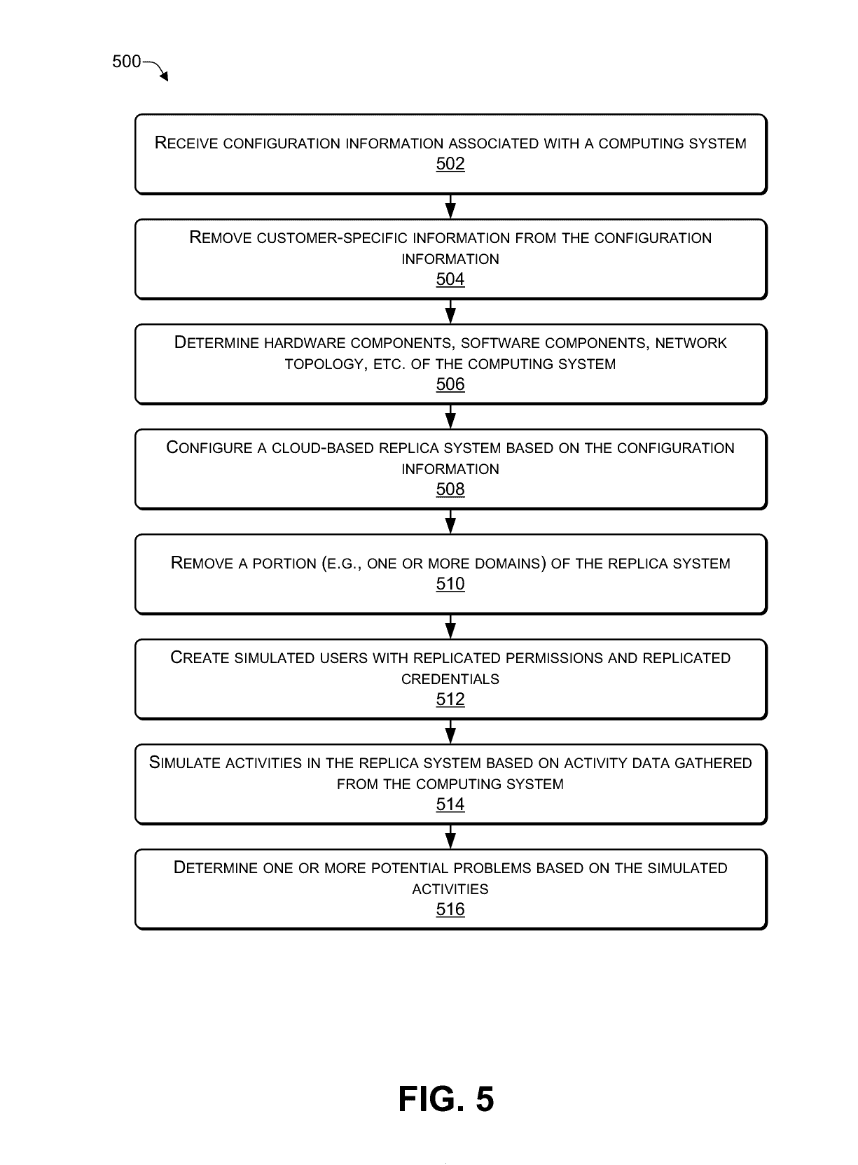

FIG. 5 is a flowchart of a process 500 that includes receiving configuration information associated with a computing system according to some embodiments. The process 500 may be performed by the replication server 202 of FIG. 2.

At 502, configuration information associated with a computing system may be received. The configuration information may be gathered by agents deployed at particular locations (e.g., domain controllers) of the computing system. At 504, customer specific data may be removed from the configuration information (e.g., to create modified configuration information). At 506, details associated with the computing system, such as details associated with the hardware components of the computing system, details associated with the software components of the computing system, details associated with the network topology of the computing system, etc. may be determined from the configuration information. At 508, a cloud-based replica system corresponding to the computing system may be configured (e.g., created or instantiated) based on the (modified) configuration information. For example, in FIG. 2, the replication server 202 may receive the configuration information 120 (or the modified configuration information 122) from the central server 110 of FIG. 1. If the replication server 202 receives the configuration information 120, the replication server 202 may remove customer-specific information from the configuration information 120 to create the modified configuration information 122. The replication server 202 may use the modified (e.g., cleaned) configuration information 122 to create a cloud-based replica system, e.g., the replicated computing system 204, corresponding to the customer's network (e.g., the computing system 100). The replicated computing system 204 may include cloud-based replicas of the hardware components (e.g., network elements) in the customer's network and the hardware components may execute cloud-based software components corresponding to the customer's network. The replicated hardware components and software components in the replicated computing system 204 may include the closest equivalents to the hardware components and the software components in the customer's network that are available in the cloud environment 206.

At 510, the cloud-based replica system may be modified (e.g., to remove portions of the network that are unrelated to a problem that the customer is encountering that the replicated system is trying to reproduce). For example, in FIG. 2, portions of the customer's network that are determined to be not directly related with a problem that the customer is encountering may be excluded from the replicated computing system 204. To illustrate, if the customer is encountering a problem related to databases 102 (e.g., the first domain 126), portions (e.g., corresponding to the domain 130) of the replicated computing system 204 that do not interact with the replicated databases 208 may be removed, deactivated, or otherwise excluded from the replicated computing system 204. As another example, both the computing system 100 and the replicated computing system 204 may include the domains and the customer may be encountering a problem in a first domain (e.g., the first domain 126) that has little or no interaction with the remaining domains (e.g., the domains 128, 130). In this example, the remaining domains may be removed or deactivated from the replicated computing system 204, leaving the first domain active to reproduce the problem. In this way, the replicated computing system 204 may be modified to remove or deactivate particular portions (e.g., domains) of the replicated computing system 204. By doing so, the amount of cloud computing resources in the cloud environment 206 that are used to reproduce the customer's problem may be reduced.

At 512, simulated users may be created with permissions and credentials that replicate users of the computing system. At 514, activities (e.g., user activities, software activities, hardware activities, and other system activities) may be simulated. For example, in FIG. 2, based on the modified configuration information 122, the replication server 202 may replicate the types of activities that occur in the computing system 100, including generating replicated user activities 218 to replicate the type of activities that users perform in the computing system 100 and replicating activities that cause replicated data 220(1) to 220(R) (e.g., corresponding to the data 118(1) to 118(R)) to be generated. Based on the modified configuration information 122, simulated users may be created with permissions, credentials, etc. similar to the users of the customer's network. The simulated users may be used to simulate activities (e.g., the replicated user activities 218) in the replicated computing system 204 that are similar to the activities that users may perform in the customer's network. For example, the modified configuration information 122 may include information associated with the types of activities that users perform and may be used to simulate user activities (e.g., the replicated user activities 218). In addition to simulating user activities, the modified configuration information 122 may be used to simulate other activities in the replicated system, such as activities performed by software processes (e.g., automatic data backup), activities that automatically take place as a result of the user activities, etc.

At 516, potential problems may be identified. For example, in FIG. 2, the replicated activities (e.g., the replicated user activities 218 and the replicated data 220) may be used to determine potential problems 224 and identify suggested solutions 226 to the potential problems 224. To illustrate, the simulated activities may be used to identify problems caused by installing incorrect software (or an incorrect software version), incorrectly configured software, incorrectly configured hardware, inefficient network topology, hardware that doesn't satisfy the requirements of software installed on the hardware, incorrect or inefficient (e.g., 10Base-T links instead of 100Base-T links) communication links between network elements, etc. A classifier (e.g., a machine learning algorithm) may be trained to identify the potential problems 224 and the potential solutions 226 to address the potential problems 224. In some cases, even if the problems that the customer is encountering are not reproducible or only partially reproducible using replicated computing system 204, the configuration problems in the customer's network may manifest as other types of problems in the replicated computing system 204 and lead to solutions that address at least some of the customer's problems. In this way, problems in the customer's network (e.g., the computing system 100) may be identified by creating the replicated computing system 204 and simulating activities.

Thus, agents may be deployed in a customer's network (e.g., enterprise network) to gather configuration information. The configuration information may be cleaned by removing customer specific information. The modified configuration information may be used to create a replicated computing system corresponding to the customer's network and to simulate activities. The simulated activities may be used to identify potential problems (e.g., configuration problems) and identify suggested solutions. In this way, a software vendor, a hardware vendor, or a solutions vendor may quickly and easily reproduce problems that a customer is encountering and suggest solutions to address the problems, resulting in fewer problems in the customer's network and greater customer satisfaction. The problems may be safely reproduced in a cloud environment without affecting the operation of the customer's network. Thus, potential problems in a customer's network may be identified with little impact on the customer's network.

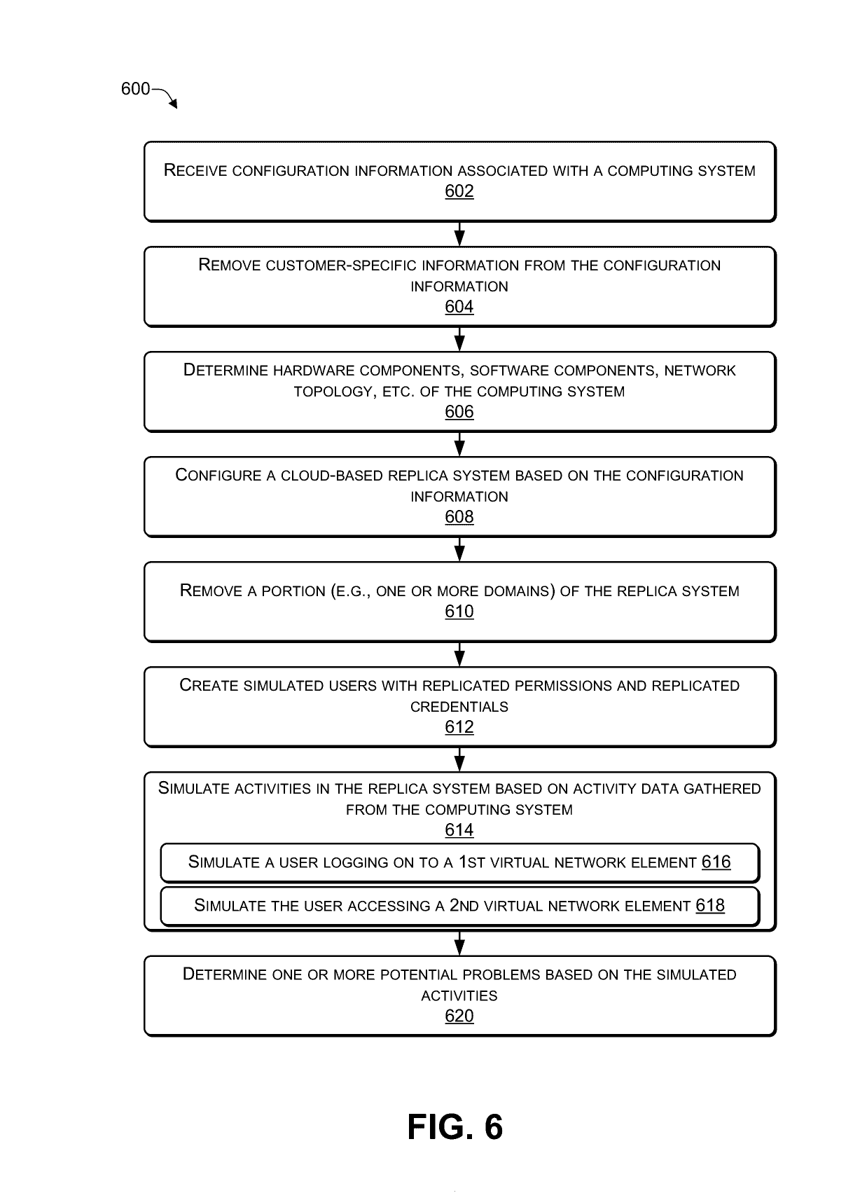

FIG. 6 is a flowchart of a process 600 that includes simulating activities in a cloud-based replica system according to some embodiments. The process 600 may be performed by the replication server 202 of FIG. 2.

At 602, configuration information associated with a computing system may be received. The configuration information may be gathered by agents deployed at particular locations (e.g., domain controllers) of the computing system. At 604, customer specific data may be removed from the configuration information (e.g., to create modified configuration information). At 606, details associated with the computing system, such as details associated with the hardware components of the computing system, details associated with the software components of the computing system, details associated with the network topology of the computing system, etc. may be determined from the configuration information. At 608, a cloud-based replica system corresponding to the computing system may be configured (e.g., created or instantiated) based on the (modified) configuration information. For example, in FIG. 2, the replication server 202 may receive the configuration information 120 (or the modified configuration information 122) from the central server 110 of FIG. 1. If the replication server 202 receives the configuration information 120, the replication server 202 may remove customer-specific information from the configuration information 120 to create the modified configuration information 122. The replication server 202 may use the modified (e.g., cleaned) configuration information 122 to create a cloud-based replica system, e.g., the replicated computing system 204, corresponding to the customer's network (e.g., the computing system 100). The replicated computing system 204 may include cloud-based replicas of the hardware components (e.g., network elements) in the customer's network and the hardware components may execute cloud-based software components corresponding to the customer's network. The replicated hardware components and software components in the replicated computing system 204 may include the closest equivalents to the hardware components and the software components in the customer's network that are available in the cloud environment 206.

At 610, the cloud-based replica system may be modified (e.g., to remove portions of the network that are unrelated to a problem that the customer is encountering that the replicated system is trying to reproduce). For example, in FIG. 2, portions of the customer's network that are determined to be not directly related with a problem that the customer is encountering may be excluded from the replicated computing system 204. To illustrate, if the customer is encountering a problem related to databases 102 (e.g., the first domain 126), portions (e.g., corresponding to the domain 130) of the replicated computing system 204 that do not interact with the replicated databases 208 may be removed, deactivated, or otherwise excluded from the replicated computing system 204. As another example, both the computing system 100 and the replicated computing system 204 may include the domains and the customer may be encountering a problem in a first domain (e.g., the first domain 126) that has little or no interaction with the remaining domains (e.g., the domains 128, 130). In this example, the remaining domains may be removed or deactivated from the replicated computing system 204, leaving the first domain active to reproduce the problem. In this way, the replicated computing system 204 may be modified to remove or deactivate particular portions (e.g., domains) of the replicated computing system 204. By doing so, the amount of cloud computing resources in the cloud environment 206 that are used to reproduce the customer's problem may be reduced.

At 612, simulated users may be created with permissions and credentials that replicate users of the computing system. At 614, activities (e.g., user activities, software activities, hardware activities, and other system activities) may be simulated. The simulated activities may include, at 616, a user logging on to a first virtual network element of the replica system using a set of user credentials (e.g., username and password), and at 618, the simulated user accessing a second virtual network element of the replica system. For example, in FIG. 2, based on the modified configuration information 122, simulated users may be created with permissions, credentials, etc. similar to the users of the customer's network. The simulated users may be used to simulate activities (e.g., the replicated user activities 218) in the replicated computing system 204 that are similar to the activities that users may perform in the customer's network. For example, the modified configuration information 122 may include information associated with the types of activities that users perform and may be used to simulate user activities (e.g., the replicated user activities 218). The user activities may include simulating a user logging on to a first network element (e.g., the replicated user device 210(N) using a first set of credentials (e.g., username and password) and simulating the user accessing another network element, e.g., the replicated database 208(M) or the replicated server 212(P) using the first set of credentials or using a second set of credentials. In this way, various problems, such as problems with credentials, problems with domain configurations, problems with permissions, incorrectly configured software, incorrectly configured hardware, etc. may be reproduced or identified. In addition to simulating user activities, the modified configuration information 122 may be used to simulate other activities in the replicated system, such as activities performed by software processes (e.g., automatic data backup), activities that automatically take place as a result of the user activities, etc.

At 620, potential problems may be identified. For example, in FIG. 2, the replicated activities (e.g., the replicated user activities 218 and the replicated data 220) may be used to determine potential problems 224 and identify suggested solutions 226 to the potential problems 224. To illustrate, the simulated activities may be used to identify problems caused by installing incorrect software (or an incorrect software version), incorrectly configured software, incorrectly configured hardware, inefficient network topology, hardware that doesn't satisfy the requirements of software installed on the hardware, incorrect or inefficient (e.g., 10Base-T links instead of 100Base-T links) communication links between network elements, etc. A classifier (e.g., a machine learning algorithm) may be trained to identify the potential problems 224 and the potential solutions 226 to address the potential problems 224. In some cases, even if the problems that the customer is encountering are not reproducible or only partially reproducible using replicated computing system 204, the configuration problems in the customer's network may manifest as other types of problems in the replicated computing system 204 and lead to solutions that address at least some of the customer's problems. In this way, problems in the customer's network (e.g., the computing system 100) may be identified by creating the replicated computing system 204 and simulating activities.

Thus, agents may be deployed in a customer's network (e.g., enterprise network) to gather configuration information. The configuration information may be cleaned by removing customer specific information. The modified configuration information may be used to create a replicated computing system corresponding to the customer's network and to simulate activities. The simulated activities may be used to identify potential problems (e.g., configuration problems) and identify suggested solutions. In this way, a software vendor, a hardware vendor, or a solutions vendor may quickly and easily reproduce problems that a customer is encountering and suggest solutions to address the problems, resulting in fewer problems in the customer's network and greater customer satisfaction. The problems may be reproduced in a cloud environment without affecting the operation of the customer's network. Thus, potential problems in a customer's network may be identified with little impact on the customer's network.

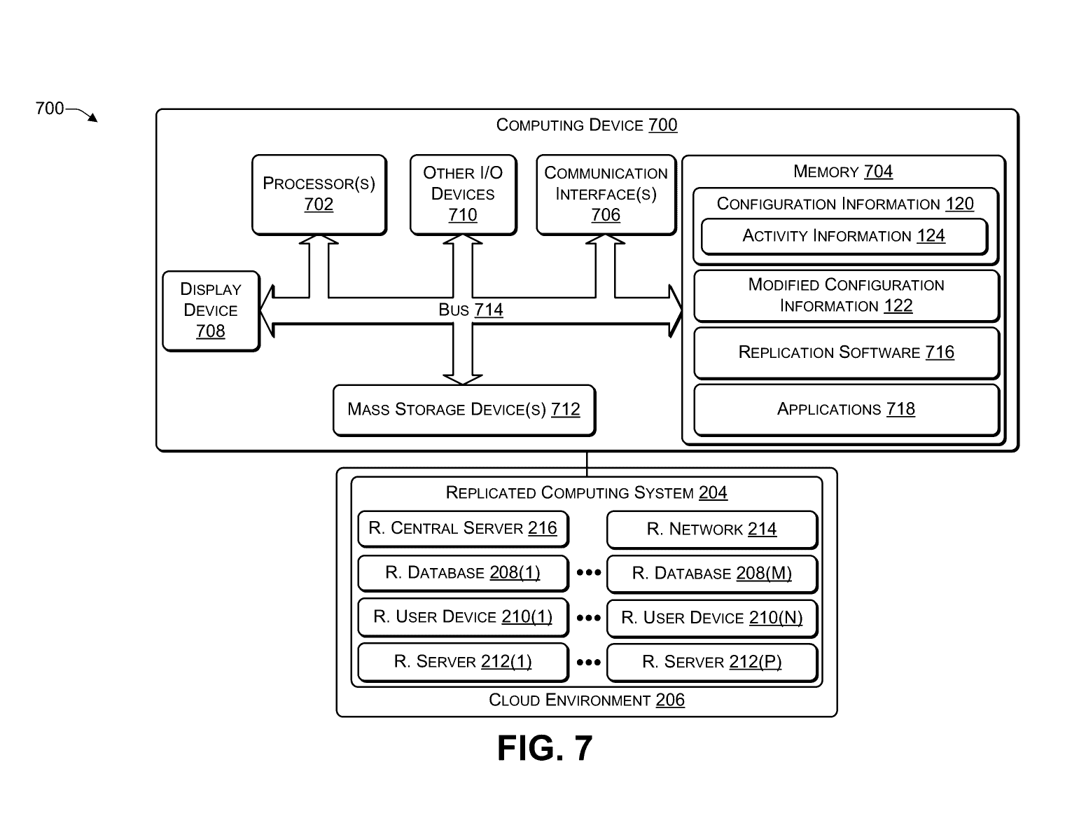

FIG. 7 illustrates an example configuration of a computing device 700 that can be used to implement the systems and techniques described herein, such as to implement the replication server 202 of FIG. 2. The computing device 700 may include one or more processors 702, a memory 704, communication interfaces 706, a display device 708, other input/output (I/O) devices 710, and one or more mass storage devices 712, configured to communicate with each other, such as via a system bus 714 or other suitable connection.

The processor 702 is a hardware device (e.g., an integrated circuit) that may include a single processing unit or a number of processing units, all or some of which may include single or multiple computing units or multiple cores. The processor 702 can be implemented as one or more microprocessors, microcomputers, microcontrollers, digital signal processors, central processing units, state machines, logic circuitries, and/or any devices that manipulate signals based on operational instructions. Among other capabilities, the processor 702 can be configured to fetch and execute computer-readable instructions stored in the memory 704, mass storage devices 712, or other computer-readable media.

Memory 704 and mass storage devices 712 are examples of computer storage media (e.g., memory storage devices) for storing instructions which are executed by the processor 702 to perform the various functions described above. For example, memory 704 may generally include both volatile memory and non-volatile memory (e.g., RAM, ROM, or the like) devices. Further, mass storage devices 712 may include hard disk drives, solid-state drives, removable media, including external and removable drives, memory cards, flash memory, floppy disks, optical disks (e.g., CD, DVD), a storage array, a network attached storage, a storage area network, or the like. Both memory 704 and mass storage devices 712 may be collectively referred to as memory or computer storage media herein, and may be a media capable of storing computer-readable, processor-executable program instructions as computer program code that can be executed by the processor 702 as a particular machine configured for carrying out the operations and functions described in the implementations herein.

The computing device 700 may also include one or more communication interfaces 706 for exchanging data via the network 108 with network elements 716. The communication interfaces 706 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, cellular, satellite, etc.), the Internet and the like. Communication interfaces 706 can also provide communication with external storage (not shown), such as in a storage array, network attached storage, storage area network, or the like.

A display device 708, such as a monitor may be included in some implementations for displaying information and images to users. Other I/O devices 710 may be devices that receive various inputs from a user and provide various outputs to the user, and may include a keyboard, a remote controller, a mouse, a printer, audio input/output devices, and so forth.

The computer storage media, such as memory 704 and mass storage devices 712, may be used to store software and data. For example, the computer storage media may be used to store replication software 716 and one or more other applications 718. The replication software 716 may be capable of modifying the configuration information 120 to create the modified configuration information 122 and to create the replicated computing system 204 in the cloud environment 206 based on the modified configuration information 122. The replication software 716 may be capable of identifying portions (e.g., domains) of the replicated computing system 204 that may not directly affect a problem and remove (or deactivate) the identified portions from the replicated computing system 204. The replication software 716 may be capable of displaying a user interface to enable a user to modify the replicated computing system 204 by enabling the user to change hardware configurations, software configurations, add or remove portions of the replicated computing system 204, and the like. For example, after a potential problem has been identified using the replicated computing system 204, the replication software 716 may provide a user interface to enable the user to modify the replicated computing system 204 to determine whether a suggested solution addresses the problem. To illustrate, the replication software 716 may create the replicated computing system 204 and simulate activities based on the activity information 124. After a potential problem is identified, the user may use the replication software 716 to modify the replicated computing system 204 to create a first modified configuration to address the problem. For example, the user may change a hardware configuration of a hardware component (e.g., more processing power, more storage, and the like), change the software configuration of a software component, change system user credentials, change permissions of one or more system users, change permissions of one or more processes, add or remove hardware components, add or remove software components, change domain configurations, modify ports, etc. The user may instruct the replication software 716 to simulate the activities in the first modified configuration. If the problem is addressed, the user may make the same or similar modifications to the customer's network (e.g., the computing system 100). If the problem is not addressed or another problem arises, the user may make additional modifications to create a second modified configuration, instruct the replication software 716 to simulate the activities in the second modified configuration, and so on until the user is satisfied that the problems have been addressed.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, and can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Software modules include one or more of applications, bytecode, computer programs, executable files, computer-executable instructions, program modules, code expressed as source code in a high-level programming language such as C, C++, Perl, or other, a low-level programming code such as machine code, etc. An example software module is a basic input/output system (BIOS) file. A software module may include an application programming interface (API), a dynamic-link library (DLL) file, an executable (e.g., .exe) file, firmware, and so forth.

Processes described herein may be illustrated as a collection of blocks in a logical flow graph, which represent a sequence of operations that can be implemented in hardware, software, or a combination thereof. In the context of software, the blocks represent computer-executable instructions that are executable by one or more processors to perform the recited operations. The order in which the operations are described or depicted in the flow graph is not intended to be construed as a limitation. Also, one or more of the described blocks may be omitted without departing from the scope of the present disclosure.

Although various embodiments of the method and apparatus of the present disclosure have been illustrated herein in the Drawings and described in the Detailed Description, it will be understood that the disclosure is not limited to the embodiments disclosed, and is capable of numerous rearrangements, modifications and substitutions without departing from the scope of the present disclosure.

What is claimed is:

1. A computer-implemented method, comprising:
receiving, by a replication server comprising a memory and one or more processors, configuration information associated with a computing system, wherein receiving the configuration information causes instructions stored in the memory to be executed by the one or more processors to perform operations comprising:
configuring a cloud-based replica system based on configuration information associated with a computing system, the cloud-based replica system including multiple virtual hardware components, wherein individual ones of the multiple virtual hardware components correspond to individual ones of multiple hardware components of the computing system;
configuring, based on the configuration information, simulated users having replicated permissions and replicated credentials;
simulating, based on activity information gathered from the computing system, activities in the cloud-based replica system, the activities including user activities performed by the simulated users; and
determining, using a classifier, one or more potential problems based on the activities in the cloud-based replica system.

2. The computer-implemented method of claim 1, the operations further comprising:
determining, based on the configuration information, that a particular hardware component of the multiple hardware components executes a particular operating system and a particular software application;
identifying a particular virtual hardware component of the multiple virtual hardware components that corresponds to the particular hardware component; and
configuring the particular virtual hardware component to execute the particular operating system and the particular software application.

3. The computer-implemented method of claim 1, the operations further comprising:
removing deployment-specific data from the configuration information.

4. The computer-implemented method of claim 3, wherein the deployment-specific data includes one or more of:
a user name, data related to the user name, metadata associated with the user name, an email address, a job code, a domain name, a server name, a port number, an internet protocol (IP) address, an active directory group name, a file name, a document name, or a site name.

5. The computer-implemented method of claim 1, the operations further comprising:
determining that a problem occurs in a first portion of the computing system;
determining that a second portion of the computing system does not affect the problem;
identifying a first cloud portion of the cloud-based replica system corresponding to the first portion of the computing system;
identifying a second cloud portion of the cloud-based replica system corresponding to the second portion of the computing system; and
removing the second cloud portion from the cloud-based replica system.

6. The computer-implemented method of claim 1, wherein the cloud-based replica system and the computing system have a similar or a same network topology.

7. The computer-implemented method of claim 1, wherein:
the configuration information is gathered by multiple agents with access to one or more domain controllers in the computing system.

8. One or more non-transitory computer-readable media storing instructions that are executable by one or more processors to perform operations comprising:
configuring a cloud-based replica system based on configuration information associated with a computing system that includes multiple hardware components, the cloud-based replica system including multiple virtual hardware components, wherein individual ones of the multiple virtual hardware components correspond to individual ones of the multiple hardware components of the computing system;
simulating user activities in the cloud-based replica system based on activity information gathered from the computing system; and
determining, using a classifier, one or more potential problems based on the user activities in the cloud-based replica system.

9. The one or more non-transitory computer-readable media of claim 8, wherein the user activities include:
logging on to a virtual user device of the cloud-based replica system using credentials associated with a simulated user; and
accessing a virtual database of the cloud-based replica system using the credentials.

10. The one or more non-transitory computer-readable media of claim 8, wherein the user activities include:
logging on to a virtual user device of the cloud-based replica system using credentials associated with a simulated user; and
accessing a software application executing on a virtual server of the cloud-based replica system using the credentials.

11. The one or more non-transitory computer-readable media of claim 8, wherein the user activities include:
logging on to a first virtual device in a first domain of the cloud-based replica system using credentials associated with a simulated user; and
accessing a second virtual device in a second domain of the cloud-based replica system using the credentials.

12. The one or more non-transitory computer-readable media of claim 8, further comprising:
removing deployment-specific data from the configuration information, wherein the deployment-specific data includes one or more of:
a user name, data related to the user name, metadata associated with the user name, an email address, a job code, a domain name, a server name, a port number, an internet protocol (IP) address, an active directory group name, a file name, a document name, or a site name.

13. The one or more non-transitory computer-readable media of claim 8, wherein:
the configuration information is gathered by multiple agents with access to one or more domain controllers in the computing system.

14. A replication server, comprising:
one or more processors; and
one or more non-transitory computer-readable media storing instructions that are executable by the one or more processors to:
receive configuration information associated with a computing system, wherein receiving the configuration information causes the one or more processors to execute the instructions to perform operations comprising:
removing customer-specific information from the configuration information to create modified configuration information;
creating, in a cloud-based environment, a replica system based on the modified configuration information, the replica system including a virtual hardware component corresponding to a hardware component of the computing system;
determining, based on activity information gathered from the computing system, permissions and credentials associated with users of the computing system;
creating simulated users with replicated permissions and replicated credentials in the replica system that are based on the permissions and the credentials associated with the users of the computing system;
simulating, based on activity information associated with the users of the computing system, user activities in the replica system; and
identifying one or more potential problems based on the user activities.

15. The replication server of claim 14, the operations further comprising:
determining, based on the configuration information, that the hardware component of the computing system executes an operating system and one or more software applications; and
configuring the virtual hardware component of the replica system to execute the operating system and the one or more software applications.

16. The replication server of claim 14, wherein the customer-specific information includes one or more of:
a user name, data related to the user name, metadata associated with the user name, an email address, a job code, a domain name, a server name, a port number, an internet protocol (IP) address, an active directory group name, a file name, a document name, or a site name.

17. The replication server of claim 14, the operations further comprising:
identifying a first replicated portion of the replica system corresponding to first portion of the computing system in which a problem occurs;
identifying a second replicated portion of the replica system corresponding to a second portion of the computing system that does not affect the problem; and
removing the second replicated portion from the replica system.

18. The replication server of claim 14, wherein the user activities include:
logging on to a virtual user device of the replica system using a set of credentials associated with a simulated user; and
accessing a virtual database of the replica system using the set of credentials.

19. The replication server of claim 14, wherein the user activities include:
logging on to a virtual user device of the replica system using a set of credentials associated with a simulated user; and
accessing a software application executing on a virtual server of the replica system using the set of credentials.

20. The replication server of claim 14, wherein the user activities include:
logging on to a first virtual device in a first domain of the replica system using a set of credentials associated with a simulated user; and
accessing a second virtual device in a second domain of the replica system using the set of credentials.
